(19) United States
(12) Patent Application Publication
(10) Pub. No.: US 2019/0392437 A1
(43) Pub. Date: Dec. 26, 2019

(54) REAL-TIME NET SETTLEMENT BY DISTRIBUTED LEDGER SYSTEM

(71) Applicant: BANK OF AMERICA CORPORATION, Charlotte, NC (US)

(72) Inventors: Brandon Matthew Castagna, Mount Holly, NC (US); Bethe Anne Warner, Charlotte, NC (US)

(73) Assignee: BANK OF AMERICA CORPORATION, Charlotte, NC (US)

(21) Appl. No.: 16/562,219

(22) Filed: Sep. 5, 2019

Related U.S. Application Data
(63) Continuation of application No. 15/935,941, filed on Mar. 26, 2018, now abandoned.
(60) Provisional application No. 62/594,968, filed on Dec. 5, 2017.

(51) Int. Cl. G06Q 20/38; G06F 16/28; G06F 16/27; G06F 16/23; G06F 21/64

(52) U.S. Cl. CPC G06Q 20/389; G06F 16/288; G06F 21/645; G06F 16/23; G06F 16/27

(57) ABSTRACT

Embodiments of the present invention provide a system operatively connected with a block chain distributed network and for using the block chain distributed network for providing aggregate tracking and threshold triggering. Embodiments receive, at a node of a blockchain distributed network, a transaction record associated with a transaction between a payor and a payee; accesses a distributed ledger; determines, from the distributed ledger, a net position between the entity and a third party; and, if the entity is the payor bank and the third party is the payee bank, debit the net position in the amount of the transaction; and, if the entity is the payee bank and the third party is the payor bank, credit the net position in the amount of the transaction, thereby resulting in an updated net position between the entity and the third party; and records the updated net position on the distributed ledger.

### CROSS-REFERENCE TO RELATED APPLICATIONS

This non-provisional U.S. patent application is a continuation application of U.S. patent application Ser. No. 15/935,941, of the same title, filed on Mar. 26, 2018, and assigned to the assignee herein, which claims priority to U.S. provisional patent application Ser. No. 62/594,968 titled “Real-Time Net Settlement by Distributed Ledger System” filed Dec. 5, 2017, assigned to the assignee hereof, all of which are hereby expressly incorporated by reference herein.

### FIELD

The present invention relates to improving settlement of transactions among institutions.

### BACKGROUND

Present conventional systems utilize nostro accounts, which are expensive to own and manage, and funding such accounts can place a strain on liquidity. Therefore, a need for a flexible and cost effective accounting treatment and system for implementing the same are needed.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the present invention address the above needs and/or achieve other advantages by providing apparatuses (e.g., a system, computer program product and/or other devices) and methods for real-time net settlement using a distributed ledger. The system embodiments may comprise one or more memory devices having computer readable program code stored thereon, a communication device, and one or more processing devices operatively coupled to the one or more memory devices.

Embodiments of the present invention provide a system operatively connected with a block chain distributed network and for using the block chain distributed network for providing aggregate tracking and threshold triggering. Embodiments receives, at a node of a blockchain distributed network, a transaction record associated with a transaction between a payor and a payee, wherein the payor is associated with a payor bank and the payee is associated with a payee bank; accesses a distributed ledger, wherein the distributed ledger is updated based on communications from the block chain distributed network; determines, from the distributed ledger, a net position between the entity and a third party; determines whether the transaction record is associated with the entity as a payor bank or a payee bank and, if the entity is the payor bank and the third party is the payee bank, debit the net position in the amount of the transaction; and, if the entity is the payee bank and the third party is the payor bank, credit the net position in the amount of the transaction, thereby resulting in an updated net position between the entity and the third party; and records the updated net position on the distributed ledger.

In some embodiments, the processing device is further configured to execute computer-readable program code to record the transaction record alongside the updated net position on the distributed ledger.

In some embodiments, the processing device is further configured to execute computer-readable program code to compare the updated net position to a predetermined threshold; and if the updated net position is greater than the predetermined threshold, initiate settlement of an amount associated with the updated net position.

In some such embodiments, the processing device is further configured to execute computer-readable program code to if the updated net position indicates the entity owes the third party the amount, initiate payment of the amount to the third party.

In other such embodiments, the processing device is further configured to execute computer-readable program code to if the updated net position indicates the third party owes the entity the amount, initiate request of the amount from the third party.

In yet other such embodiments, the processing device is further configured to execute computer-readable program code to determine settlement of the amount has occurred; and update the updated net position based on the settlement. In some of these embodiments, the processing device is further configured to execute computer-readable program code to record settlement between the entity and the third party on a second distributed ledger different than the distributed ledger.

In some embodiments, the processing device is further configured to execute computer-readable program code to access a set of rules configured to cause the system to settle with one or more third parties based on a plurality of criteria.

According to embodiments of the invention, a computer program product for using a block chain distributed network for facilitating real-time net settlement includes at least one non-transitory computer readable medium comprising computer readable instructions, and the instructions, when executed by a computer processor, cause the computer processor to receive, at a node of a block chain distributed network, a transaction record associated with a transaction between a payor and a payee, wherein the payor is associated with a payor bank and the payee is associated with a payee bank; access a distributed ledger, wherein the distributed ledger is updated based on communications from the block chain distributed network; determine, from the distributed ledger, a net position between the entity and a third party; determine whether the transaction record is associated with the entity as a payor bank or a payee bank and if the entity is the payor bank and the third party is the payee bank, debit the net position in the amount of the transaction; and if the entity is the payee bank and the third party is the payor bank, credit the net position in the amount of the transaction, thereby resulting in an updated net position between the entity and the third party; and record the updated net position on the distributed ledger.

In some embodiments, the computer readable instructions further cause the computer processor to record the transaction record alongside the updated net position on the distributed ledger.

In some embodiments, the computer readable instructions further cause the computer processor to compare the updated net position to a predetermined threshold; and if the updated net position is greater than the predetermined threshold, initiate settlement of an amount associated with the updated net position.

In some embodiments, the computer readable instructions further cause the computer processor to if the updated net position indicates the entity owes the third party the amount, initiate payment of the amount to the third party.

In some embodiments, the computer readable instructions further cause the computer processor to if the updated net position indicates the third party owes the entity the amount, initiate request of the amount from the third party.

In some embodiments, the computer readable instructions further cause the computer processor to determine settlement of the amount has occurred; and update the updated net position based on the settlement.

In some of these embodiments, the computer readable instructions further cause the computer processor to record settlement between the entity and the third party on a second distributed ledger different than the distributed ledger.

In some embodiments, the computer readable instructions further cause the computer processor to access a set of rules configured to cause the system to settle with one or more third parties based on a plurality of criteria.

According to embodiments of the invention, a computer implemented method for using the block chain distributed network for facilitating real-time net settlement includes receiving, at a node of a block chain distributed network, a transaction record associated with a transaction between a payor and a payee, wherein the payor is associated with a payor bank and the payee is associated with a payee bank; accessing a distributed ledger, wherein the distributed ledger is updated based on communications from the block chain distributed network; determining, from the distributed ledger, a net position between the entity and a third party; determining whether the transaction record is associated with the entity as a payor bank or a payee bank and if the entity is the payor bank and the third party is the payee bank, debiting the net position in the amount of the transaction; and if the entity is the payee bank and the third party is the payor bank, crediting the net position in the amount of the transaction, thereby resulting in an updated net position between the entity and the third party; and recording the updated net position on the distributed ledger.

In some embodiments, the method includes recording the transaction record alongside the updated net position on the distributed ledger.

In some embodiments, the method includes comparing the updated net position to a predetermined threshold; and if the updated net position is greater than the predetermined threshold, initiating settlement of an amount associated with the updated net position.

In some such embodiments, the method includes, if the updated net position indicates the entity owes the third party the amount, initiating payment of the amount to the third party.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a block diagram illustrating the real-time net settlement system environment, in accordance with embodiments of the present invention.

FIG. 2A illustrates a traditional centralized ledger system.

FIG. 2B is a diagram illustrating a distributed ledger system used in embodiments of the invention.

FIG. 3 is a diagram illustrating a blockchain distributed ledger system according to embodiments of the invention.

FIG. 4 is a flowchart illustrating a method for real-time net settlement using a distributed ledger according to embodiments of the invention.

FIG. 5 is a diagram that illustrates a traditional banking relationship settlement scheme.

FIG. 6 is a diagram illustrating a “just-in-time” or real-time net settlement based on distributed ledger scheme according to embodiments of the present invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Systems, methods, and computer program products are herein disclosed that provide for real-time net settlement using a distributed ledger system. Presently, basic bank-to-bank accounting is a very expensive endeavor. Multiple accounts are required to be maintained by people on both sides of the transactions. Accounts have exception processes that are managed by people as well. Embodiments of the present invention consolidate multiple physical bank accounts using distributed ledger technologies. Instead of creating individual relationships with every external third party, embodiments of the invention involve creating a centralized single account. When a settlement is necessary, the money from the single account may be moved based on a set of rules dictating the relationship between two entities. Because the settlement system leverages a distributed ledger system, both “sides” of the transaction are aware of, and can verify, the status of the account throughout a cycle, such as throughout a day. Because the distributed ledger system is a trusted system, then the present system obviates the need to hold individual, unique accounts for each third party. Utilizing the distributed ledger, both sides of the settlement have access to various details regarding the balance throughout the cycle, and the rules may dictate a transfer via wire, ACH or otherwise. For example, the rules may dictate a transfer once the balance reaches a threshold level or at a certain time of day, for example, fifteen (15) minutes prior to closing the cycle (e.g., the day).

By taking this approach, movement of payments is improved drastically. The money is centralized in a repository, thereby improving cash management services. The money is moved in bulk rather than moved individually by single transaction or small batch of transactions. This reduces the chances of losing an individual payment on the payment rails (bank settlement communication channels). As mentioned above, because of the transaction data present and verified on the distributed ledger, the transaction is trusted. Exceptions and amount of money being moved are both reduced.

The rules may be dynamic and provide the money exactly when required by one or both of the parties to the transaction.

In other embodiments, a distributed ledger need not be used. Rather, both sides of the transaction may keep its own ledger and rules. For example, providing messaging between entities through a cycle that includes details regarding balances between the entities. Each side may maintain its own ledger or accounting details, and settlement may be made at a predetermined time or threshold, such as at the end of day. If an entity requires settlement, for example, four (4) times a day, then the settlement rules may be implemented so that the settlement occurs based on those rules. In other words, both sides maintain an understanding of the position, and both sides would maintain a procedure for truing-up any discrepancies in the positions. Thus, there may be instances where discrepancies occur, and both sides would need to work to remedy the discrepancies in order to facilitate the system without a distributed ledger.

In essence, the system provides a real-time settling of funds without necessarily requiring a third party intermediary. The distributed ledger provides increased visibility and trust. The two-way messaging system may provide for managing synchronization of positions. This two-way messaging system may include instructions (outbound information/transactions) and events (status updates). The two-way communication results in the synchronization of the position based on both sides understanding the messaging.

In other words, embodiments of the present invention provide a system operatively connected with a block chain distributed network and for using the block chain distributed network for providing aggregate tracking and threshold triggering. Embodiments receives, at a node of a blockchain distributed network, a transaction record associated with a transaction between a payor and a payee, wherein the payor is associated with a payor bank and the payee is associated with a payee bank; accesses a distributed ledger, wherein the distributed ledger is updated based on communications from the block chain distributed network; determines, from the distributed ledger, a net position between the entity and a third party; determines whether the transaction record is associated with the entity as a payor bank or a payee bank and, if the entity is the payor bank and the third party is the payee bank, debit the net position in the amount of the transaction; and, if the entity is the payee bank and the third party is the payor bank, credit the net position in the amount of the transaction, thereby resulting in an updated net position between the entity and the third party; and records the updated net position on the distributed ledger.

In accordance with embodiments of the invention, the terms “entity system” may include any organization such as one that processes financial transactions including, but not limited to, banks, credit unions, savings and loan associations, card associations, settlement associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution or a potential customer of the financial institution or an employee of the financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

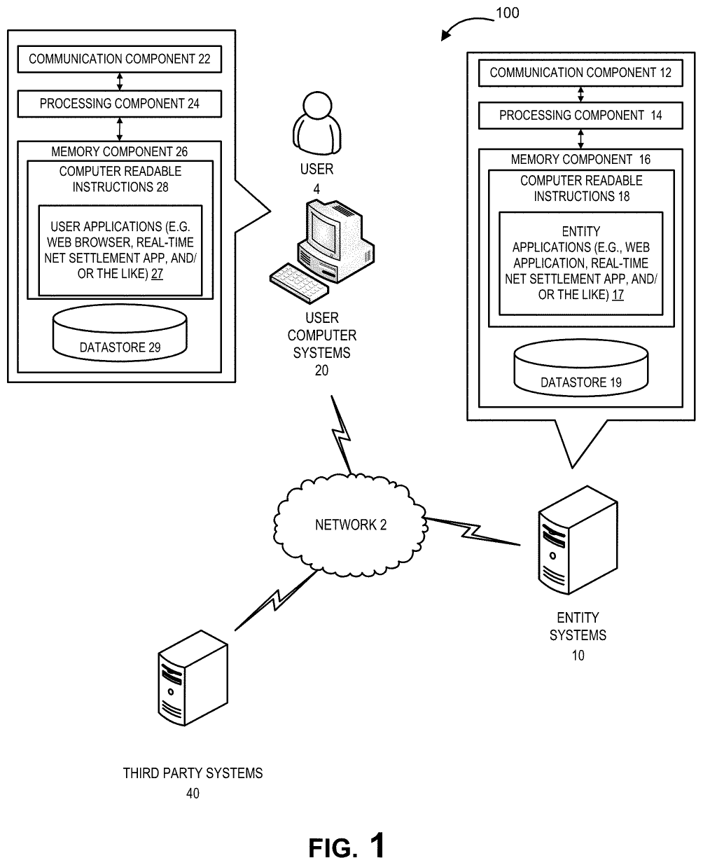

FIG. 1 illustrates a real-time net settlement system environment 100, in accordance with embodiments of the invention. As illustrated in FIG. 1, one or more entity systems 10 are operatively coupled, via a network 2, to user computer systems 20, a plurality of user computer systems, and/or one or more other systems (not illustrated). In this way, the user 4 (e.g., one or more associates, employees, agents, contractors, sub-contractors, third-party representatives, customers, or the like), through a user application 27 (e.g., web browser, real-time net settlement application, or the like), may access entity applications 17 (e.g., website, real-time net settlement application, or the like) of the entity systems 10 to perform net settlement using distributed ledgers as discussed herein. In some embodiments, the real-time net settlement application may be a part of an independent real-time net settlement system. In such an embodiment, the independent real-time net settlement system is maintained and operated by the entity systems 10. The independent real-time net settlement system may comprise one or more processing devices operatively coupled to the one or more memory devices and configured to execute computer readable code stored in the one or more memory devices.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the entity systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the components of the user computer systems 20, third-party systems 40, or other systems. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like. In one embodiment of the present invention, the one or more processing components 14 automatically implement a distributed ledger used for tracking balances as between an entity and third parties.

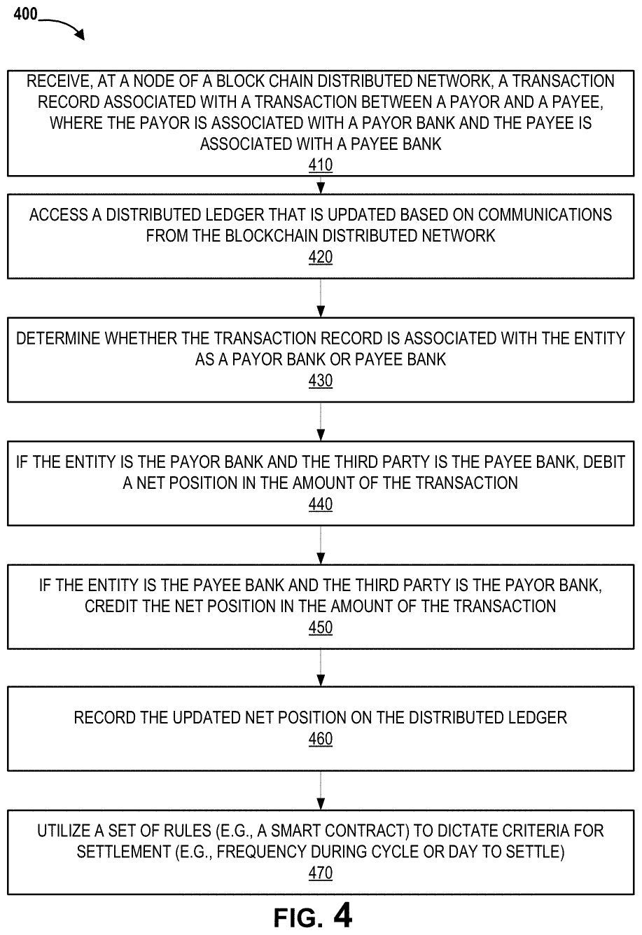

As further illustrated in FIG. 1, the entity systems 10 comprise computer-readable instructions 18 stored in the memory component 16, which in one embodiment includes the computer-readable instructions 18 of the entity application 17 (e.g., website application, real-time net settlement application, and/or the like). In some embodiments, the one or more memory components 16 include one or more data stores 19 for storing data related to the entity systems 10, including, but not limited to, data created, accessed, and/or used by the entity application 17. The one or more data stores may store the copies of the distributed ledger, historical data, and/or other information. In one embodiment of the present invention, the real-Page time net settlement application comprises a rules engine to perform one or more steps described in the process flows of FIG. 4.

As illustrated in FIG. 1, users 4 may access the application 17, or other applications, through a user computer system 20. The user computer system 20 may be a desktop, mobile device (e.g., laptop, smartphone device, PDA, tablet, or other mobile device), or any other type of computer that generally comprises one or more communication components 22, one or more processing components 24, and one or more memory components 26.

The one or more processing components 24 are operatively coupled to the one or more communication components 22 and the one or more memory components 26. The one or more processing components 24 use the one or more communication components 22 to communicate with the network 2 and other components on the network 2, such as, but not limited to, the user computer systems 20, third party systems 40, and/or other systems. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with the users 4. In one embodiment of the present invention, the real-time net settlement application in the user computer systems 20, the third party systems 40, and the entity systems 10 may comprise a special net settlement interface to display information associated with the one or more distributed ledgers, the balances of the accounts for each third party, the process steps discussed herein and the automatic actions that may be taken in response to the net settlement processes discussed herein. Such information may be displayed to the user and the interface may receive information associated with the rules and/or the one or more distributed ledgers or otherwise from the user.

As illustrated in FIG. 1, the user computer systems 20 may have computer-readable instructions 28 stored in the one or more memory components 26, which in one embodiment includes the computer-readable instructions 28 for user applications 27, such as real-time net settlement application (e.g., apps, applet, or the like), portions of real-time net settlement application, a web browser or other apps that allow the user 4 to take various actions, including allowing the user 4 to access applications located on other systems, or the like. In some embodiments, the user 4 utilizes the user applications 27, through the user computer systems 20, to access the entity applications 17 to perform net settlement transactions or analysis. The third party systems 40 associated with a plurality of user 5 may include similar structure as that of the user computer systems 20.

Some embodiments of this invention utilize a distributed ledger, such as a distributed ledger as used in a block chain infrastructure. Block chain may use a specialized distributed ledger system for storing each process point of the complete payment structure for each transaction together in a block chain style format. The blocks store data packets of information pertaining to the processing of that particular transaction within the process and are chained together to form a time stamped historic record of the transaction processed from the client origination to external clearing. Using metadata the system allows for searching and finding complex tracking and tracing across individual transactions or accounts.

“Block chain” as used herein refers to a decentralized electronic ledger of data records which are authenticated by a federated consensus protocol. Multiple computer systems within the block chain, referred to herein as “nodes” or “compute nodes,” each comprise a copy of the entire ledger of records. Nodes may write a data “block” to the block chain, the block comprising data regarding a transaction. In some embodiments, only miner nodes may write transactions to the block chain. In other embodiments, all nodes have the ability to write to the block chain. In some embodiments, the block may further comprise a time stamp and a pointer to the previous block in the chain. In some embodiments, the block may further comprise metadata indicating the node that was the originator of the transaction. In this way, the entire record of transactions is not dependent on a single database which may serve as a single point of failure; the block chain will persist so long as the nodes on the block chain persist. A “private block chain” is a block chain in which only authorized nodes may access the block chain. In some embodiments, nodes must be authorized to write to the block chain. In some embodiments, nodes must also be authorized to read from the block chain. Once a transactional record is written to the block chain, it will be considered pending and awaiting authentication by the miner nodes in the block chain.

“Miner node” as used herein refers to a networked computer system that authenticates and verifies the integrity of pending transactions on the block chain. The miner node ensures that the sum of the outputs of the transaction within the block matches the sum of the inputs. In some embodiments, a pending transaction may require validation by a threshold number of miner nodes. Once the threshold number of miners has validated the transaction, the block becomes an authenticated part of the block chain. By using this method of validating transactions via a federated consensus mechanism, duplicate or erroneous transactions are prevented from becoming part of the accepted block chain, thus reducing the risk of data record tampering and increasing the security of the transactions within the system.

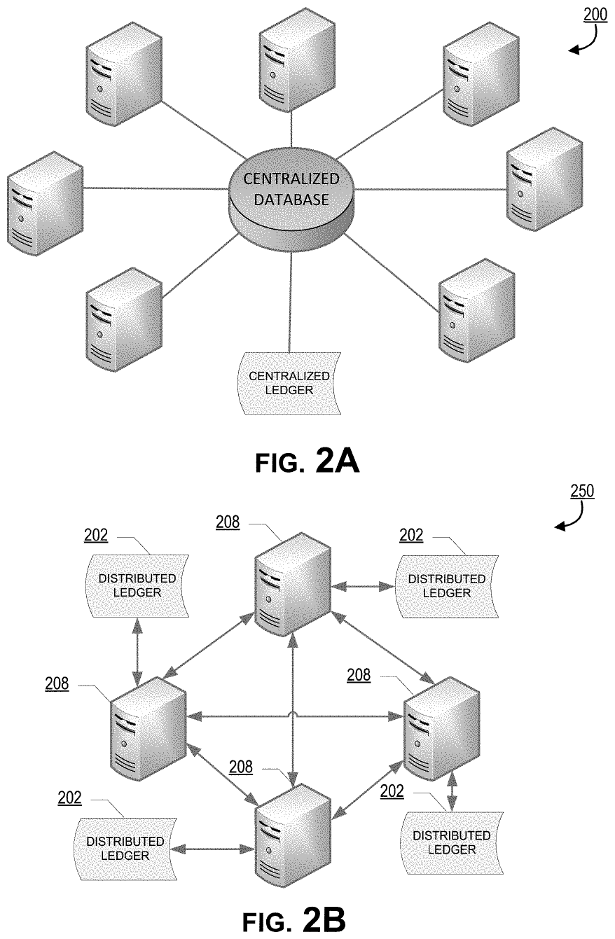

FIG. 2A illustrates a centralized database architecture environment 200, in accordance with one embodiment of the present invention. The centralized database architecture comprises multiple nodes from one or more sources and converge into a centralized database. The system, in this embodiment, may generate a single centralized ledger for data received from the various nodes. The single centralized ledger for data provides a difficult avenue for reviewing a record of a single transaction or payment process as it moves through the various applications for processing. There is no means to track the individual payment through the process at any point until it has been completely posted. Even at that point, with the amount of data a centralized database digests regularly in a complex payment structure, the ability to accurately track and trace a single transaction point or account through the process is not possible.

FIG. 2B provides a general block chain system environment architecture 250, in accordance with one embodiment of the present invention. Rather than utilizing a centralized database of data for instrument conversion, as discussed above in FIG. 2A, various embodiments of the invention may use a decentralized block chain configuration or architecture as shown in FIG. 2B in order to facilitate the converting of an instrument from a non-secured or secured format to a verified secured format. Such a decentralized block chain configuration ensures accurate mapping of resources available within an account associated with an instrument. Accordingly, a block chain configuration may be used to maintain an accurate ledger of transactions and the processing of each transaction through the processing applications by generation of a time stamped block and building of one or more blocks for each stage of the processing for the transaction. In this way, the system builds a traceable and trackable historic view of each transaction within each account, capable of being searched and identified.

A block chain is a distributed database that maintains a list of data records, such as real-time resource availability associated with one or more accounts or the like, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. As such, the status of the instrument and the resources associated therewith can be validated and cleared by one participant.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In some embodiments, the block chain system is closed, as such the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria.

As mentioned above and referring to FIG. 2B, a block chain system 250 is typically decentralized—meaning that a distributed ledger 202 (i.e., a decentralized ledger) is maintained on multiple nodes 408 of the block chain 250. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains. In some embodiments, the nodes 208 of the system might be financial institutions that function as gateways for other financial institutions. For example, a credit union might hold the account, but access the distributed system through a sponsor node.

Various other specific-purpose implementations of block chains have been developed. These include distributed domain name management, decentralized crowd-funding, synchronous/asynchronous communication, decentralized real-time ride sharing and even a general purpose deployment of decentralized applications.

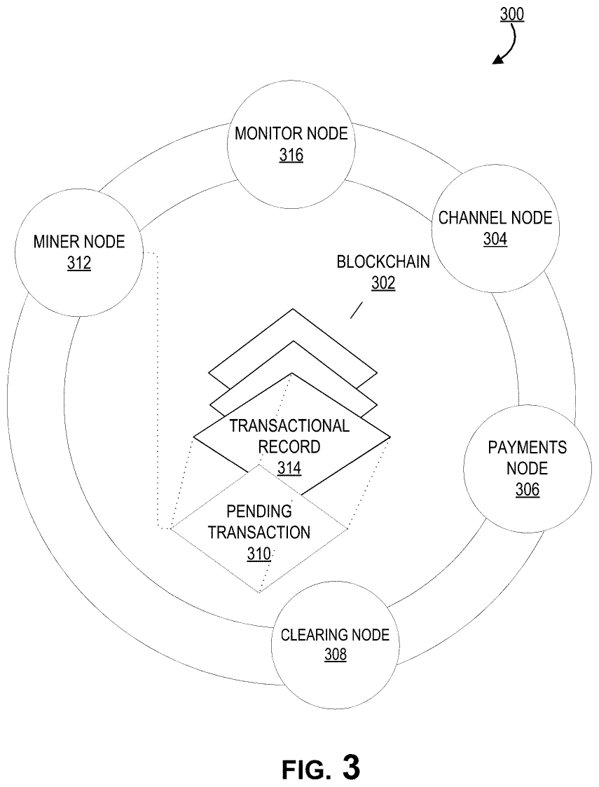

FIG. 3 provides a high level process flow illustrating node interaction within a block chain system environment architecture 300, in accordance with one embodiment of the present invention. As illustrated and discussed above, the block chain system may comprise at least one or more nodes used to generate blocks and process transactional records for generation of the life-cycle record recreation.

In some embodiments, the channel node 304, payments node 306, or the clearing node 308 may publish a pending transaction 310 to the block chain 302. At this stage, the transaction has not yet been validated by the miner node(s) 312, and the other nodes will delay executing their designated processes. The miner node 312 may be configured to detect a pending transaction 310 or steps in the processing of the payment transaction in the block chain and conduct its processes to evaluate the validity of the data therein. Upon verifying the integrity of the data in the pending transaction 310, the miner node 312 validates the transaction and adds the data as a transactional record 314, which is referred to as a block in some embodiments of the application, to the block chain 302. Once a transaction has been authenticated in this manner, the nodes will consider the transactional record 314 to be valid and thereafter execute their designated processes accordingly. The transactional record 314 will provide information about what process or application the payment transaction was just processed through and metadata coded therein for searchability of the transactional record 314 within a distributed ledger.

In some embodiments, the system may comprise at least one additional miner node 312. The system may require that pending transactions 310 be validated by a plurality of miner nodes 312 before becoming authenticated blocks on the block chain. In some embodiments, the systems may impose a minimum threshold number of miner nodes 312 needed to verify each pending transaction. The minimum threshold may be selected to strike a balance between the need for data integrity/accuracy versus expediency of processing. In this way, the efficiency of the computer system resources may be maximized.

Furthermore, in some embodiments, a plurality of computer systems are in operative networked communication with one another through a network. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

In some embodiments, the computer systems represent the nodes of the block chain, such as the miner node or the like. In such an embodiment, each of the computer systems comprise the block chain, providing for decentralized access to the block chain 302 as well as the ability to use a consensus mechanism to verify the integrity of the data therein.

Various embodiments provide a system operatively connected with a block chain distributed network and for using the block chain distributed network for providing aggregate tracking and threshold triggering. Embodiments receives, at a node of a blockchain distributed network, a transaction record associated with a transaction between a payor and a payee, wherein the payor is associated with a payor bank and the payee is associated with a payee bank; accesses a distributed ledger, wherein the distributed ledger is updated based on communications from the block chain distributed network; determines, from the distributed ledger, a net position between the entity and a third party; determines whether the transaction record is associated with the entity as a payor bank or a payee bank and, if the entity is the payor bank and the third party is the payee bank, debit the net position in the amount of the transaction; and, if the entity is the payee bank and the third party is the payor bank, credit the net position in the amount of the transaction, thereby resulting in an updated net position between the entity and the third party; and records the updated net position on the distributed ledger.

In various embodiments of the invention, existing payment networks (such as EWS, TCH, debit networks, etc.) may be combined with a distributed ledger technology (DLT)-based clearing chain (or blockchain) associated with one or more entity-third party relationships. In some embodiments, another blockchain provides a settlement ledger between an entity and one or more third parties. In some such embodiments, one or more smart contracts dictate the interaction between the blockchains by enabling rules that dictate one or more thresholds for comparing net positions between the entity-third party pairs so that settlements may be initiated when thresholds are passed. Payment messages are delivered on existing networks and are also sent to the clearing blockchain. In some embodiments, within the blockchain, transactions are recorded and net positions are calculated from an entity to each counterparty.

In various embodiments, a variety of triggers may initiate settlement of a net position between an entity and a third party. Such triggers may be implemented by one or more smart contracts and may include government regulations, public information such as interest rates or the like, and/or private information known to the entity because of its relationship with a third party. For example, the government may dictate that a particular institution may only have a first level of exposure, and rules may implement the first level of exposure by a smart contract that compares the net position to the first level and initiates a settlement if the net position exceeds the threshold.

This type of configuration provides a more efficient process for interaction between institutions as the number of settlements between the institutions may be drastically reduced. This is because, currently, institutions may be transferring a first amount from the first entity to a second entity and the second entity may be transferring a second amount from the second entity to the first entity. If a net position had been calculated, then only one transfer would have been necessary, or possibly none if the net position was low enough not to trigger a settlement. Any payment network that allows payments to be sent from bank to bank may be used for settlement in conjunction with embodiments of the invention, and in fact, such payment network may be or include a previously existing network such as a credit card network, ACH network, wire network or any other network.

Referring now to FIG. 4, a flowchart illustrates a method 400 for real-time net settlement using a distributed ledger according to embodiments of the invention. The first step, as represented by block 410, is to receive, at a node of a blockchain distributed network, a transaction record associated with a transaction between a payor and a payee. The payor is associated with a payor bank and the payee is associated with a payee bank. The next step, as represented by block 420, is to access a distributed ledger that is updated based on communications from the blockchain distributed network. Next, as represented by block 430, the system determines whether the transaction record is associated with the entity as a payor bank or payee bank. Then, if the entity is the payor bank and the third party is the payee bank, the system debits a net position in the amount of the transaction, thereby maintaining an accurate, ongoing net position between the entity and the third party, as represented by block 440. Next, if the entity is the payee bank and the third party is the payor bank, the system credits the net position in the amount of the transaction, as represented by block 450. In this way, multiple entity-third party net positions may be maintained on a single or multiple clearance blockchains. Finally, as represented by block 460, the system records the updated net position on the distributed ledger (i.e., blockchain).

In various embodiments, a set of rules such as a smart contract dictates criteria for settlement, as represented by block 470. For example, the settlement frequency during a cycle such as a day may be dictated by the set of rules.

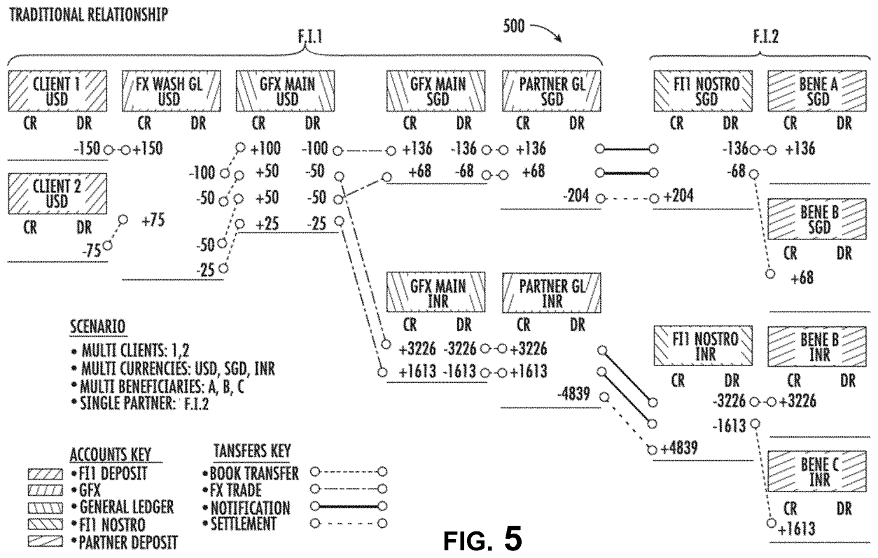

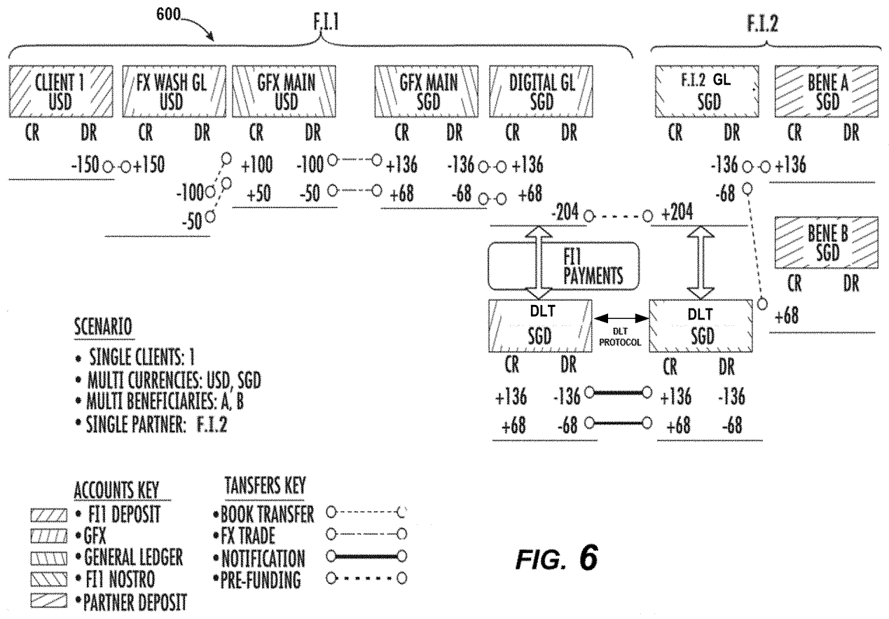

Referring now to FIG. 5, a diagram illustrates a traditional banking relationship settlement scheme. Referring now to FIG. 6, a diagram illustrates a “just-in-time” or real-time net settlement based on distributed ledger scheme. As shown, FIG. 6 illustrates transfer of net position funds between two banking entities, where at least one of the banks maintains a single account (client 1) that is designated for use with a single third party banking partner and capable of transacting in multiple currencies for monetary transfers to multiple beneficiaries (Beneficiary A and Beneficiary B) associated with the third party banking partner.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system operatively connected with a block chain distributed network and for using the block chain distributed network for facilitating real-time net settlement, the system maintained by an entity, the system comprising:
a memory device; and
a processing device operatively coupled to the memory device, wherein the processing device is configured to execute computer-readable program code to:
receive, at a node of a block chain distributed network, a transaction record associated with a transaction between a payor and a payee, wherein the payor is associated with a payor bank and the payee is associated with a payee bank;
access a distributed ledger, wherein the distributed ledger is updated based on communications from the block chain distributed network;
determine, from the distributed ledger, a net position between the entity and a third party;
determine whether the transaction record is associated with the entity as a payor bank or a payee bank and:
if the entity is the payor bank and the third party is the payee bank, debit the net position in the amount of the transaction; and
if the entity is the payee bank and the third party is the payor bank, credit the net position in the amount of the transaction,
thereby resulting in an updated net position between the entity and the third party;
record the updated net position on the distributed ledger;
identify a trigger based on a set of rules; and
in response to identifying the trigger, initiate real-time net settlement of funds associated with the updated net position via a centralized single account maintained by the entity.

2. The system of claim 1, wherein the processing device is further configured to execute computer-readable program code to:
record the transaction record alongside the updated net position on the distributed ledger.

3. The system of claim 1, wherein the real-time net settlement of the funds is associated with multiple currencies and the centralized account.

4. The system of claim 1, wherein the processing device is configured to identify the trigger based on performing at least one of:
comparing the updated net position to a predetermined threshold and determining that the updated net position is greater than a threshold;
comparing a current time period to a predetermined time period and determining that the current time period is equal to the predetermined time period.

5. The system of claim 4, wherein the processing device is further configured to execute computer-readable program code to:
if the updated net position indicates the entity owes the third party the amount, initiate payment of the funds from the centralized single account associated maintained by the entity to another centralized single account maintained by the third party.

6. The system of claim 4, wherein the processing device is further configured to execute computer-readable program code to:
if the updated net position indicates the third party owes the entity the amount, initiate request of the funds from another centralized single account maintained by the third party to the centralized single account maintained by the entity.

7. The system of claim 1, wherein the processing device is further configured to execute computer-readable program code to:
determine the real-time net settlement of the funds is complete; and
update the updated net position based on the real-time net settlement.

8. The system of claim 7, wherein the processing device is further configured to execute computer-readable program code to:
in response to determining that the real-time net settlement is complete, record the real-time net settlement between the entity and the third party on a second distributed ledger different than the distributed ledger.

9. A computer program product for using a block chain distributed network for facilitating real-time net settlement, wherein the computer program product comprises at least one non-transitory computer readable medium comprising computer readable instructions, the instructions, when executed by a computer processor, cause the computer processor to:
receive, at a node of a block chain distributed network, a transaction record associated with a transaction between a payor and a payee, wherein the payor is associated with a payor bank and the payee is associated with a payee bank;
access a distributed ledger, wherein the distributed ledger is updated based on communications from the block chain distributed network;
determine, from the distributed ledger, a net position between the entity and a third party;
determine whether the transaction record is associated with the entity as a payor bank or a payee bank and:
if the entity is the payor bank and the third party is the payee bank, debit the net position in the amount of the transaction; and
if the entity is the payee bank and the third party is the payor bank, credit the net position in the amount of the transaction,
thereby resulting in an updated net position between the entity and the third party; and
record the updated net position on the distributed ledger;
identify a trigger based on a set of rules; and
in response to identifying the trigger, initiate real-time net settlement of funds associated with the updated net position via a centralized single account maintained by the entity.

10. The computer program product of claim 9, wherein the computer readable instructions further cause the computer processor to:
record the transaction record alongside the updated net position on the distributed ledger.

11. The computer program product of claim 9, wherein the real-time net settlement of the funds is associated with multiple currencies and the centralized single account.

12. The computer program product of claim 9, wherein the computer readable instructions cause the computer processor to identify the trigger based on performing at least one of:
comparing the updated net position to a predetermined threshold and determining that the updated net position is greater than a threshold;
comparing a current time period to a predetermined time period and determining that the current time period is equal to the predetermined time period.

13. The computer program product of claim 12, wherein the computer readable instructions further cause the computer processor to:
if the updated net position indicates the entity owes the third party the funds, initiate payment of the funds from the centralized single account maintained by the entity to another centralized single account maintained by the third party.

14. The computer program product of claim 12, wherein the computer readable instructions further cause the computer processor to:
if the updated net position indicates the third party owes the entity the funds, initiate request of the funds from another centralized single account associated with the third party to the centralized single account associated with the entity.

15. The computer program product of claim 11, wherein the computer readable instructions further cause the computer processor to:
determine the real-time net settlement of the funds is complete; and
update the updated net position based on the real-time net settlement.

16. The computer program product of claim 15, wherein the computer readable instructions further cause the computer processor to:
in response to determining that the real-time net settlement is complete, record the real-time net settlement between the entity and the third party on a second distributed ledger different than the distributed ledger.

17. A computer implemented method for using the block chain distributed network for facilitating real-time net settlement, the computer implemented method comprising:
receiving, at a node of a block chain distributed network, a transaction record associated with a transaction between a payor and a payee, wherein the payor is associated with a payor bank and the payee is associated with a payee bank;
accessing a distributed ledger, wherein the distributed ledger is updated based on communications from the block chain distributed network;
determining, from the distributed ledger, a net position between the entity and a third party;
determining whether the transaction record is associated with the entity as a payor bank or a payee bank and:
if the entity is the payor bank and the third party is the payee bank, debiting the net position in the amount of the transaction; and
if the entity is the payee bank and the third party is the payor bank, crediting the net position in the amount of the transaction, thereby resulting in an updated net position between the entity and the third party; and
recording the updated net position on the distributed ledger;
identify a trigger based on a set of rules; and
in response to identifying the trigger, initiate real-time net settlement of funds associated with the updated net position via a centralized single account maintained by the entity.

18. The computer implemented method of claim 17, further comprising:
recording the transaction record alongside the updated net position on the distributed ledger.

19. The computer implemented method of claim 17, the method of identifying the trigger comprises performing at least one of:
comparing the updated net position to a predetermined threshold and determining that the updated net position is greater than a threshold;
comparing a current time period to a predetermined time period and determining that the current time period is equal to the predetermined time period.

20. The computer implemented method of claim 19, further comprising:
if the updated net position indicates the entity owes the third party the funds, initiating payment of the funds from the centralized single account associated with the entity to another centralized single account associated with the third party; and
if the updated net position indicates the third party owes the entity the funds, initiate request of the funds from another centralized single account associated with the third party to the centralized single account associated with the entity.
